(19) United States
(12) Patent Application Publication
(10) Pub. No.: US 2010/0276995 A1
(43) Pub. Date: Nov. 4, 2010

(54) Security for wireless transfer of electrical power

(76) Inventors: Thomas Louis Marzetta, Summit, NJ (US); Christopher A. White, Neshanic Station, NJ (US)

Correspondence Address: Docket Administrator - Room 3D-201E;Alcatel-Lucent USA Inc., 600-700 Mountain Avenue, Murray Hill, NJ, 07974, US

(21) Appl. No.: 12/387,192

(22) Filed: Apr. 29, 2009

(51) Int. Cl. H02J 17/00; H04Q 5/22

(52) U.S. Cl. 307/11; 307/104; 340/10.34

(57) ABSTRACT

A security mechanism is provided for wireless power transfer applications including resonant source and device objects, wherein tuned resonance between source and device objects is necessary for efficient power transfer. Tuning parameters associated with the source object are periodically adjusted so as to require corresponding changes in tuning parameter(s) of the device object to maintain tuned resonance. The tuning parameters are communicated to authorized users such that only authorized users capable of matching the changes made by the transmitter would be capable of receiving power. Unauthorized users that are unaware of the transmit tuning parameters will be rendered unable to maintain tuned resonance and thus unable to receive power.

### FIELD OF THE INVENTION

This invention relates generally to wireless electrical power transfer and, more particularly to a security solution for wireless electrical power transfer.

### BACKGROUND OF THE INVENTION

Significant progress has been made in recent years in the concept of wireless electrical power transfer, whereby principles of electromagnetic coupling can be utilized to power or charge electrical devices that are not in direct contact with a power source. Thus far, commercial applications have been limited to very close-range or very low-power energy transfers, however it has been determined experimentally that wireless transfer can be accomplished at mid-range distances (e.g., extending a few meters from the power source). If wireless power transfer at mid-range distances can be commercialized, there are many potential applications including, without limitation, the powering or charging of laptops, cell phones, robots, RFIDs and electric vehicles.

It is contemplated by applicants that security would be an integral part of any practical wireless power transfer application, e.g., to ensure that power delivered by the wireless transfer is received only by authorized users.

### SUMMARY

This need is addressed and a technical advance is achieved in the art by providing a security mechanism for wireless power transfer applications involving tuned resonant transmit and receive media. Tuning parameter(s) of the transmit media are periodically altered so as to require corresponding changes in tuning parameter(s) of the receive media to maintain tuned resonance (necessary for efficient power transfer). In such manner, only authorized users capable of matching the changes made by the transmitter would be capable of receiving power. Unauthorized users that are unaware of the transmit tuning parameters will be rendered unable to maintain tuned resonance and thus unable to receive power.

In one embodiment, there is provided a method, carried out in a wireless electrical power transfer system including a source object operable to wirelessly transfer electrical power to a device object when the source and device objects are in tuned resonance, comprising steps of periodically adjusting tuning parameters of the source object, yielding a number of resonant frequency changes of the source object; and communicating indicia of the frequency changes to authorized users associated with the device object, such that corresponding resonant frequency changes can be made in the device object to maintain tuned resonance with the source object.

In another embodiment, there is provided a corresponding method, carried out in a wireless electrical power transfer system including a source object operable to wirelessly transfer electrical power to a device object when the source and device objects are in tuned resonance, comprising steps of receiving indicia of resonant frequency changes of the source object; and periodically adjusting tuning parameters of the device object, yielding a number of resonant frequency changes of the device object corresponding to the frequency changes of the source object to maintain tuned resonance with the source object.

In yet another embodiment, there is provided an apparatus comprising a processor and memory, operable in a wireless electrical power transfer system including a source object operable to wirelessly transfer electrical power to a device object when the source and device objects are in tuned resonance, to (i) periodically adjust tuning parameters of the source object, yielding a number of resonant frequency changes of the source object; and (ii) communicate indicia of the frequency changes to authorized users associated with the device object, such that corresponding resonant frequency changes can be made in the device object to maintain tuned resonance with the source object.

In still yet another embodiment, there is provided an apparatus comprising a processor and memory, operable in a wireless electrical power transfer system including a source object operable to wirelessly transfer electrical power to a device object when the source and device objects are in tuned resonance, to (i) receive indicia of resonant frequency changes of the source object; and (ii) periodically adjust tuning parameters of the device object, yielding a number of resonant frequency changes of the device object corresponding to the frequency changes of the source object to maintain tuned resonance with the source object.

### BRIEF DESCRIPTION OF THE DRAWINGS

The foregoing and other advantages of the invention will become apparent upon reading the following detailed description and upon reference to the drawings in which:

FIG. 1 is a block diagram of an exemplary wireless electrical power transfer system of the prior art;

FIG. 2 shows an equivalent circuit of the system of FIG. 1;

FIG. 3 is a block diagram illustrating a wireless electrical power transfer system according to an embodiment of the present invention, having adjustable tuning parameters to implement wireless power transfer to authorized users;

FIG. 4 is a flowchart of steps performed by a transmitter of the wireless electrical power transfer system of FIG. 3 to implement wireless power transfer to authorized users; and

FIG. 5 is a flowchart of steps performed by a receiver of the wireless electrical power transfer system of FIG. 3 to implement wireless power transfer to authorized users.

### DESCRIPTION OF THE PREFERRED EMBODIMENT(S)

FIG. 1 illustrates an exemplary wireless electrical power transfer system 100 of the prior art. A driving circuit 102 comprising, e.g., a Colpitts oscillator with a copper loop of radius 25 cm produces a sine wave with frequency 9.9 MHz within vicinity of a resonant coil (“source coil”) 104 so as to induce resonance of the source coil. The resonant source coil 104 produces an omnidirectional “tail” of energy (i.e., slowly decaying magnetic field) up to several meters in length that can be utilized for mid-range power transfer with a corresponding device coil 106 that is “strongly coupled” to the source coil. Strong coupling can be achieved, for example, if the source and device coils are in tuned resonance (i.e., have the same resonant frequency) and have overlapping tails. In one example, source and device coils 104, 106 comprise, e.g., helical copper loops having 5.25 turns, radius 30 cm and height 20 cm and a resonant frequency of 10.56 MHz. The device coil 106 is connected to a load 108 comprising, e.g., a lightbulb attached to its own copper loop that inductively couples to the device coil. In one example, the lightbulb was powered wirelessly at a distance of two meters with an efficiency of approximately 40%.

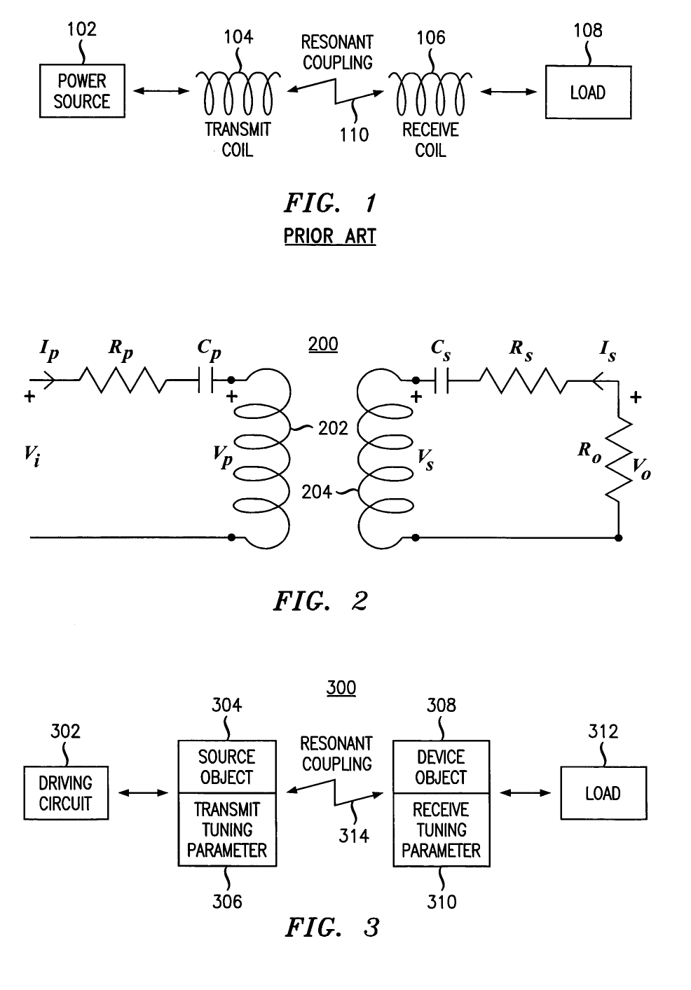

FIG. 2 shows an equivalent circuit model of the system of FIG. 1. Resonant coupling between source and device coils is represented by a transformer 200 comprising primary and secondary windings 202, 204, albeit with very low coupling between the windings. In series with each winding is a series resistance, Rₚ and Rₛ respectively, and a series capacitance, Cₚ and Cₛ respectively. The secondary circuit terminates in a load resistor, Rₒ. Each of the series resistances is the sum of two terms comprising the actual resistance of the winding plus the radiation resistance of the coil,

Rₚ=R_{pΩ}++Rₚᵣ, Rₛ=R_{sΩ}+Rₛᵣ. (1)

The series capacitance of each winding can either be associated with the parasitic capacitance of the winding or with an actual capacitor.

The relationships between the voltages and currents associated with the transformer windings are

Vₚ=iωLₚIₚ+iωMIₛ

Vₛ=iωMIₚ+iωLₛIₛ, (2)

where Lₚ and Lₛ are the primary and secondary inductance respectively, and M is the mutual inductance. The coupling coefficient is denoted by k,

$$k = \frac{M}{\sqrt{{L}_{p} {L}_{s}}} , \vert k \vert \leq 1. \qquad ( 3 )$$

The secondary voltage can be expressed in terms of the secondary current as follows,

$${V}_{s} = - {I}_{s} ( \frac{1}{iω {C}_{s}} + {R}_{s} + {R}_{o} ) . \qquad ( 4 )$$

The substitution of (4) into the second expression in (2) yields the current transfer ratio,

$$\frac{{I}_{s}}{{I}_{p}} = \frac{- iω M}{{R}_{s} + {R}_{o} + \frac{1}{iω {C}_{s}} + iω {L}_{s}} . \qquad ( 5 )$$

The power transfer efficiency, denoted γ, is the ratio of the power dissipated in the load resistance divided by the total dissipated power,

$$\begin{matrix}γ = \frac{{\vert {I}_{s} \vert}^{2} {R}_{o}}{{\vert {I}_{p} \vert}^{2} {R}_{p} + {\vert {I}_{s} \vert}^{2} ( {R}_{s} + {R}_{o} )} \\ = \frac{{\vert {I}_{s} / {I}_{p} \vert}^{2} {R}_{o} / {R}_{p}}{1 + {\vert {I}_{s} / {I}_{p} \vert}^{2} ( {R}_{s} + {R}_{o} ) / {R}_{p}} .\end{matrix} \qquad ( 6 )$$

The wasted power is dissipated in heating the coils and radiating electromagnetic power.

Resonance in the Secondary Circuit

It is apparent that the efficiency increases monotonically with the magnitude of the current transfer ratio, (5). In turn, the current transfer ratio is maximized when the following resonance condition is satisfied in the secondary circuit,

$$0 = \frac{1}{iω {C}_{s}} + iω {L}_{s} , or {ω}^{2} {L}_{s} {C}_{s} = 1. \qquad ( 7 )$$

If this resonance condition is satisfied then the current transfer ratio becomes

$$\frac{{I}_{s}}{{I}_{p}} = \frac{- iω M}{{R}_{s} + {R}_{o}} , \qquad ( 8 )$$

and the optimized power transfer efficiency becomes

$$\begin{matrix}γ = \frac{( \frac{{( ω M )}^{2} {R}_{o}}{{{R}_{p} ( {R}_{s} + {R}_{o} )}^{2}} )}{( 1 + \frac{{( ω M )}^{2}}{{R}_{p} ( {R}_{s} + {R}_{o} )} )} \\ = \frac{( \frac{{β}^{2} {\overline{R}}_{o}}{{( 1 + {\overline{R}}_{o} )}^{2}} )}{( 1 + \frac{{β}^{2}}{( 1 + {\overline{R}}_{o} )} )} ,\end{matrix} \qquad ( 9 )$$

where R̅ₒ is the normalized load resistance,

$${\overline{R}}_{o} = \frac{{R}_{o}}{{R}_{s}} , \qquad ( 10 )$$

and β is a parameter defined as follows

$$\begin{matrix}β ≡ \frac{ω M}{\sqrt{{R}_{p} {R}_{s}}} \\ = k \sqrt{{Q}_{p} {Q}_{s}} ,\end{matrix} \qquad ( 11 )$$

where k is the coupling coefficient (3), and Qₚ and Qₛ are the Q's (ratio of the reactance to the resistance) for the primary and secondary windings respectively,

$${Q}_{p} = \frac{ω {L}_{p}}{{R}_{p}} , {Q}_{s} = \frac{ω {L}_{s}}{{R}_{s}} . \qquad ( 12 )$$

### Optimization With Respect to the Apparent Load Resistance

The apparent load resistance, Rₒ, does not have to be equal to the actual resistance of the load. Instead an r.f. transformer can convert the actual load resistance to any desired apparent load resistance.

It is both useful and feasible to maximize the power transfer efficiency (9) with respect to the apparent load resistance, which yields the following optimal value,

Rₒ=Rₛ\sqrt{1+β²}. (13)

The substitution of (13) into (9) yields the optimized power transfer efficiency,

$$γ = {( \frac{β}{1 + \sqrt{1 + {β}^{2}}} )}^{2} . \qquad ( 14 )$$

For a desired power transfer efficiency, the expression (14) can be solved to obtain the required value of β,

$$β = \frac{2 \sqrt{γ}}{1 - γ} . \qquad ( 15 )$$

Importance of Resonance in the Secondary Circuit

Consider the case where the capacitor in the secondary circuit is shorted (equivalently Cₛ=∞). Then the current transfer ratio becomes

$${\vert \frac{{I}_{s}}{{I}_{p}} \vert}^{2} = \frac{{ω}^{2} {M}^{2}}{{( {R}_{s} + {R}_{o} )}^{2} + {ω}^{2} {L}_{s}^{2}} , \qquad ( 16 )$$

and the power transfer efficiency is

$$γ = \frac{{ω}^{2} {M}^{2} {R}_{o}}{{R}_{p} ( {( {R}_{s} + {R}_{o} )}^{2} + {ω}^{2} {L}_{s}^{2} ) + {ω}^{2} {M}^{2} ( {R}_{s} + {R}_{o} )} . \qquad ( 17 )$$

As before we can optimize the power transfer efficiency with respect to the apparent load resistance to obtain

Rₒ=Rₛ\sqrt{1+β²+Qₛ²}, (18)

which, when substituted into (16), yields the optimized power transfer efficiency,

$$γ = \frac{{β}^{2}}{2 + {β}^{2} + 2 \sqrt{1 + {β}^{2} + {Q}_{s}^{2}}} , \qquad ( 19 )$$

where β is given by (11), and Qₛ by (12). For example let β=2.11, which if the resonance condition holds and the apparent load resistance is optimized yields an efficiency of 0.40. Assume that Qₛ=1000. Then the efficiency in the absence of resonance (e.g. (19)) is only γ=0.0022. Thus resonance in the secondary circuit is exceedingly important.

Resonance in the Primary Circuit

For a given value of the secondary current, Iₛ, we can solve for the primary current, Iₚ, through (8), where Rₒ is given by (18),

$${I}_{p} = \frac{{I}_{s} ( {R}_{s} + {R}_{o} )}{- iω M} . \qquad ( 20 )$$

The first formula of (2) gives Vₚ as a function of Iₛ,

$${V}_{p} = ( iω M - \frac{{L}_{p} ( {R}_{s} + {R}_{o} )}{M} ) {I}_{s} . \qquad ( 21 )$$

We can obtain an expression for Vᵢ in terms of Vₚ and Iₚ, and therefore in terms of Iₛ, to obtain the following

$${V}_{i} = ( \frac{{ω}^{2} {M}^{2} + {R}_{p} ( {R}_{s} + {R}_{o} )}{- iω M} + \frac{( 1 - {ω}^{2} {L}_{p} {C}_{p} ) ( {R}_{s} + {R}_{o} )}{{ω}^{2} {MC}_{p}} ) {I}_{s} . \qquad ( 22 )$$

For a given power that is delivered to the load we can minimize the magnitude of the voltage that must be supplied by the power amplifier by satisfying the resonance condition in the primary circuit,

ω²LₚCₚ=1, (23)

which yields

$${V}_{i} = ( \frac{{ω}^{2} {M}^{2} + {R}_{p} ( {R}_{s} + {R}_{o} )}{- iω M} ) {I}_{s} . \qquad ( 24 )$$

The division of (24) by (20) yields the impedance which the power amplifier sees,

$$\begin{matrix}{V}_{i} = \frac{{ω}^{2} {M}^{2} + {R}_{p} ( {R}_{s} + {R}_{o} )}{{R}_{s} + {R}_{o}} \\ = {R}_{p} \sqrt{1 + {β}^{2}} ,\end{matrix} \qquad ( 25 )$$

which is a pure resistance.

Summary of Results

There are two activities which affect the power transfer efficiency. By far the more important activity is to maintain resonance in the secondary circuit via (7). Optimum impedance matching between the secondary circuit and the load can also yield significant improvements in efficiency: the optimum apparent load resistance is given by the expression (13), where the parameter β is given by the expression (11). The combination of secondary resonance and optimum impedance matching yields the optimized power transfer efficiency (14). Maintaining resonance in the primary circuit through (23) does not affect the efficiency, but is advantageous in presenting a purely resistive load to the power amplifier (equivalently a high power factor). When primary resonance holds, the power amplifier feeds a pure resistance (25).

The optimized performance of the wireless power transfer scheme is determined entirely by the parameter β (11). In turn, a high frequency, a high mutual inductance, and low primary and secondary resistances (including both the ohmic resistances and the radiation resistances) are conducive to making β big. Over a wide range of frequency, the mutual inductance is approximately constant. Hence high frequencies have an inherent advantage over 50 or 60 Hz. However as frequency increases, both the ohmic resistance (because of the skin effect) and the radiation resistance increase. The radiation resistance increases as the fourth power of frequency when the total length of the coil winding is much less than the wavelength. Hence for a given coil geometry there is some optimum frequency which maximizes β. At coil spacings much greater than the diameters of the coils, the mutual inductance (when calculated according to the field of an ideal magnetic dipole) decreases as the cube of the spacing.

Now turning to FIG. 3, there is shown a wireless electrical power transfer system 300 according to an embodiment of the present invention. The system includes a driving circuit 302 for delivering energy to a source object 304 so as to induce resonance of the source object. In one embodiment, the source object 304 comprises a tunable resonant coil (for example and without limitation, a helical copper loop) and the driving circuit comprises an oscillator to drive the source coil to resonance. In general, the source object may characterize any type of resonant structure and the driving circuit will vary depending on the type of resonant structure.

A transmit tuning parameter element 306 operates to periodically alter one or more transmit tuning parameters associated with the source object so as to change (“retune”) the resonant frequency of the source object. The term “tuning parameters,” as used herein, encompasses generally any parameters that may affect the resonant frequency of the source object, including physical parameters of the source object and/or characteristics of the driving circuit that may affect the resonant frequency of the source object. For example and without limitation, in the case where the source object comprises a resonant coil, the resonant frequency may be altered by varying the capacitance Cₚ or the inductance Lₚ of the source coil or by varying the oscillation frequency of the driving circuit. In one embodiment, frequency-hopping spread-spectrum techniques (familiar in wireless communications) are used to produce a predetermined pattern of frequency changes known to both the transmitter and to authorized users. Generally, frequency retuning can be accomplished in any manner presently known or devised in the future, either in a predetermined pattern or on an ad-hoc basis and communicated to authorized users.

The system 300 further includes one or more resonant device objects 308 (one shown) and receive tuning parameter element(s) 310. In one embodiment, the device object 308 comprises a tunable resonant coil (for example and without limitation, a helical copper loop) corresponding to the source object 304. In general, the device object 308 may characterize any type of resonant structure. Mid-range power transfer can be accomplished from the source object 304 to the device object 308 if the source and device objects are “strongly coupled,” which may be characterized mathematically by the parameter beta (referring to Eq. 11) having a value in the neighborhood of 1 or 2. This can be achieved when the source object and device object have high Q values (referring to Eq. 12) and they are tuned to resonate at the same resonant frequency.

The receive tuning parameter element 310 operates to periodically alter one or more receive tuning parameters associated with the device object so as to change (“retune”) the resonant frequency of the device object. The term “tuning parameters” encompasses generally any parameters that may affect the resonant frequency of the device object, including, without limitation, physical parameters of the device object. Advantageously, the receive tuning parameters are retuned in corresponding fashion as the transmit tuning parameters of the source object so as to achieve or maintain tuned resonance with the source object 304. For example and without limitation, in the case where the device object comprises a resonant coil, the resonant frequency may be altered by varying the capacitance Cₚ or the inductance Lₚ of the device coil, and tuned resonance can be achieved or maintained if the changes correspond to those made in the source coil. In one embodiment, the frequency changes are made in a predetermined pattern known to both transmitter and receiver. Alternatively, frequency changes may be communicated to the receiver on an ad hoc basis.

The device object 308 is connected to a load 312 comprising, for example and without limitation, a portable electric device or battery. When resonant coupling 314 is achieved and maintained, power can be wirelessly delivered to the load 312 at mid-range distances. Because tuned resonance is necessary for efficient power transfer, only authorized users having knowledge of frequency changes made by the transmitter would be capable of maintaining tuned resonance and receiving power. Unauthorized users that are unaware of the transmit tuning parameters will be rendered unable to maintain tuned resonance and thus unable to receive power.

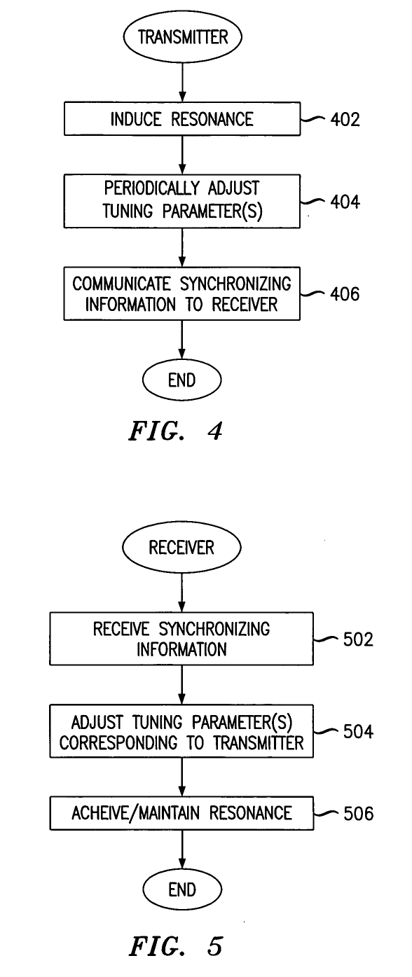

Now referring to FIG. 4, transmitter functionality of the wireless electrical power transfer system of FIG. 3 will be described in greater detail. The steps of FIG. 4 are implemented, where applicable, by the driving circuit 302, source object 304 and transmit tuning parameter element 306, associated computing devices (for example and without limitation, programmed processor(s) operably connected to the driving circuit 302, source object 304 and transmit tuning parameter element 306) and/or human operation. The sequence of steps of FIG. 4 need not be performed in the order shown.

At step 402, resonance of the source object 304 is induced. In one exemplary embodiment, the source object 304 comprises a tunable resonant coil and resonance is induced by driving the source with a driving circuit 302 comprising an oscillator. However, the source object may characterize virtually any resonant object and the driving circuit will vary depending on the type of resonant structure.

At step 404, one or more tuning parameters associated with the source object 304 are periodically adjusted so as to change (“retune”) the resonant frequency of the source object. Frequency changes may be implemented in a predetermined pattern or on an ad hoc basis by the transmit tuning parameter element 306. In the case where frequency tuning is accomplished in a predetermined pattern, the pattern may be stored locally relative to the transmit tuning parameter element 306 or stored remotely and retrieved or communicated to the transmit tuning parameter element 306.

At step 406, synchronizing information is communicated to authorized receivers. The synchronizing information may comprise, without limitation, state information including indicia of the frequency changes or tuning parameters of the transmitter, timing information associated with the frequency changes or code sequences, pattern information or the like from which authorized users can derive state information of the transmitter. Communication of synchronizing information is accomplished via one or more functional links (not shown) which may comprise, for example, wired or wireless links, satellite links, switches, gateways, interconnecting networks or the like. As will be appreciated, the functional links may implement generally any air interface, circuit or packet switching technology presently known or devised in the future.

Advantageously, authorized users having received the synchronizing information can adjust their tuning parameters to correspond to those of the transmitter so as to achieve or maintain tuned resonance with the transmitter; whereas unauthorized users not having received the synchronizing information will be unable to maintain tuned resonance and thus unable to receive power.

Now referring to FIG. 5, receiver functionality of the wireless electrical power transfer system of FIG. 3 will be described in greater detail. The steps of FIG. 5 are implemented, where applicable, by the device object 308, receive tuning parameter element 310, load 312, associated computing devices (for example and without limitation, programmed processor(s) operably connected to the device object 308, receive tuning parameter element 310, load 312) and/or human operation.

At step 502, synchronizing information is received by authorized users. As described in relation to FIG. 4, the synchronizing information may comprise, without limitation, state information including indicia of the frequency changes or tuning parameters of the transmitter, timing information associated with frequency changes, or code sequences, pattern information or the like from which authorized users can derive state information of the transmitter. Communication of synchronizing information is accomplished via one or more functional links (not shown) which may comprise, for example, wired or wireless links, satellite links, switches, gateways, interconnecting networks or the like. As will be appreciated, the functional links may implement generally any air interface, circuit or packet switching technology presently known or devised in the future.

At step 504, one or more tuning parameters of the device object 308 are adjusted to the resonant frequency of the source object such that at step 506, tuned resonance is achieved or maintained with the source object to achieve wireless power transfer. Advantageously, only authorized users having received the synchronizing information can achieve or maintain tuned resonance with the transmitter; whereas unauthorized users not having received the synchronizing information will be unable to maintain tuned resonance and thus unable to receive power.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. For example, a person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

The scope of the invention is, therefore, indicated by the appended claims rather than by the foregoing description. All changes that come within the meaning and range of equivalency of the claims are to be embraced within their scope.

What is claimed is:

1. In a wireless electrical power transfer system including a source object operable to wirelessly transfer electrical power to a device object when the source and device objects are in tuned resonance, a method comprising:
periodically adjusting tuning parameters associated with the source object, yielding a number of resonant frequency changes of the source object; and
communicating indicia of the frequency changes to authorized users associated with the device object, such that corresponding resonant frequency changes can be made in the device object to maintain tuned resonance with the source object.

2. The method of claim 1, wherein the step of periodically adjusting tuning parameters yields a predetermined pattern of resonant frequency changes.

3. The method of claim 2 wherein the step of communicating comprises communicating one or more of: the frequency changes, synchronizing information, the tuning parameters and the predetermined pattern to the authorized users.

4. The method of claim 1, wherein the source object comprises a resonant coil, the step of periodically adjusting tuning parameters comprises adjusting one or more of: the capacitance or inductance of the source coil.

5. An article of manufacture comprising a processor-readable storage medium storing one or more software programs which when executed by a processor associated with the source object perform the steps of the method of claim 1.

6. In a wireless electrical power transfer system including a source object operable to wirelessly transfer electrical power to a device object when the source and device objects are in tuned resonance, a method comprising:
receiving indicia of resonant frequency changes of the source object; and
periodically adjusting tuning parameters associated with the device object, yielding a number of resonant frequency changes of the device object corresponding to the frequency changes of the source object to maintain tuned resonance with the source object.

7. The method of claim 6, wherein the device object comprises a resonant coil, the step of periodically adjusting tuning parameters comprises adjusting one or more of: the capacitance or inductance of the device coil.

8. An article of manufacture comprising a processor-readable storage medium storing one or more software programs which when executed by a processor associated with the device object perform the steps of the method of claim 6.

9. In a wireless electrical power transfer system including a source object operable to wirelessly transfer electrical power to a device object when the source and device objects are in tuned resonance, an apparatus comprising:
a memory; and
a processor coupled to the memory and configured to: (i) periodically adjust tuning parameters associated with the source object, yielding a number of resonant frequency changes of the source object; and (ii) communicate indicia of the frequency changes to authorized users associated with the device object, such that corresponding resonant frequency changes can be made in the device object to maintain tuned resonance with the source object.

10. In a wireless electrical power transfer system including a source object operable to wirelessly transfer electrical power to a device object when the source and device objects are in tuned resonance, an apparatus comprising:
a memory; and
a processor coupled to the memory and configured to: (i) receive indicia of resonant frequency changes of the source object; and (ii) periodically adjust tuning parameters associated with the device object, yielding a number of resonant frequency changes of the device object corresponding to the frequency changes of the source object to maintain tuned resonance with the source object.
